(19) United States
(12) Patent Application Publication
(10) Pub. No.: US 2008/0225387 A1
(43) Pub. Date: Sep. 18, 2008

(54) COLLECTOR FOR ILLUMINATION SYSTEMS WITH A WAVELENGTH LESS THAN OR EQUAL TO 193 nm

(75) Inventors: Joachim Hainz, Jena (DE); Martin Endres, Koenigsbronn (DE); Wolfgang Singer, Aalen (DE); Bernd Kleemann, Aalen (DE); Dieter Bader, Obergroeningen (DE)

Correspondence Address: FISH & RICHARDSON PC, P.O. BOX 1022, MINNEAPOLIS, MN, 55440-1022, US

(73) Assignee: CARL ZEISS SMT AG, Oberkochen (DE)

(21) Appl. No.: 12/053,305

(22) Filed: Mar. 21, 2008

Related U.S. Application Data
(63) Continuation of application No. PCT/EP2006/010004, filed on Oct. 17, 2006.
(60) Provisional application No. 60/727,892, filed on Oct. 18, 2005.

(51) Int. Cl. G02B 5/08

(52) U.S. Cl. 359/351; 359/350

(57) ABSTRACT

Collectors are disclosed. The collectors can be for illumination systems with a wavelength ≦193 nm, including ≦126 nm, and the EUV range. The collectors can serve to receive the light rays emitted from a light source and to illuminate an area in a plane. The collectors can include at least a first mirror shell or a first shell segment as well as a second mirror shell or a second shell segment receiving the light and providing a first illumination and a second illumination in a plane which is located in the light path downstream of the collector. An illumination systems are also disclosed. The illumination systems can be equipped with a collector. Projection exposure apparatuses are also disclosed. The projection exposure apparatuses can include an illumination system. Methods for the manufacture of microstructures by photographic exposure are also disclosed.

### CROSS-REFERENCE TO RELATED PATENT APPLICATIONS

The application is a continuation of PCT/EP2006/010004, filed Oct. 17, 2006, which claims the priority and the benefit of U.S. Provisional Application 60/727,892, filed Oct. 18, 2005. The contents of these applications are hereby incorporated in their entirety into the present application.

### FIELD

The disclosure relates to a collector for illumination systems with a wavelength ≦193 nm, including ≦126 nm, and the EUV range, which serve to receive the light rays emitted from a light source and to illuminate an area in a plane. The collector can include at least a first mirror shell or a first shell segment as well as a second mirror shell or a second shell segment receiving the light and providing a first illumination and a second illumination in a plane which is located in the light path downstream of the collector. The disclosure further provides an illumination system that is equipped in particular with a collector of this kind, as well as a projection exposure apparatus with an illumination system according to the disclosure, and a method for the manufacture of microstructures by photographic exposure.

### BACKGROUND

It is known to use collectors to collect light rays emitted by a light source and to illuminate an area in a plane, wherein the collectors have an aperture on the object side receiving the light rays emitted by a light source and also have a large number of rotationally symmetric mirror shells which are on a common axis of rotational symmetry and wherein a ring aperture element of the aperture on the object side is assigned to each of the mirror shells. The area to be illuminated in a plane that lies in the light path downstream of the collector can consist of ring elements.

### SUMMARY

In some embodiments, the disclosure can avoid certain drawbacks of known collectors and systems. In certain embodiments, the disclosure provides a collector configured so that, when the collector is used in an illumination system, for example in a microlithography apparatus, the loss of light is minimized in comparison to certain known systems.

In some embodiments, the disclosure can minimize the strong change of the uniformity in the field plane of the illumination system which, when using known collectors, can occur as a result of thermal deformation of the collector shells or degradation of the coatings on the collector shells.

In a first aspect of the disclosure, the loss of light in a nested collector, i.e. in a collector with at least two mirror shells arranged inside each other, can be minimized due to the fact that the mirror shells are closed mirror surfaces which have a rotationally symmetric part and a part that is not rotationally symmetric. A collector in which two mirror shells are arranged inside each other is also referred to as a nested collector.

A closed mirror surface in the context of the present application means an uninterrupted surface. An uninterrupted surface is a surface swept by an azimuth angle (from 0 to 2π.

In some embodiments, the rotationally symmetric part includes for example a first portion configured, e.g. as a first segment of a rotational hyperboloid, and a second portion configured, e.g. as a second segment of a rotational ellipsoid. The part that is not rotationally symmetric is for example added to or subtracted from the second part, wherein the parts have the forms of segments. As an alternative, the part that is not rotationally symmetric can be added to or subtracted from the first segment or both segments.

In some embodiments, a collector is proposed which consists of a first and an adjacent second surface. “Adjacent” in this context means that the two surfaces have a certain geometric distance from each other and are not intersecting each other. If surfaces have a nested arrangement, meaning that they lie inside each other, this represents a special case of the general arrangement with two mutually spaced-apart surfaces.

Each of the two surfaces with its surface points is defined by an axis and by the respective distances of the points relative to this axis. This axis for each surface in the present case is considered to be the z-axis of a coordinate system. An x-y plane extends orthogonal to the z-axis, which can also be defined in terms of polar coordinates by a radius r and an azimuth angle Φ. For a rotationally symmetric surface the distance of the points of the surface from the z-axis is only a function of the z-coordinate, meaning that the shape of the surface in the z-direction is described by a surface function K(z). The curvature of the surface perpendicular to the z-direction is thus given by a circle of radius K(z). Examples for surfaces of this kind are rotational hyperboloids, rotational ellipsoids or rotational parabolaloids or generally the lateral surfaces of bodies of rotation. For example, in the case of a rotational parabola, the function for the curvature perpendicular to the z-axis would be a circle with a radius which at different locations along the z-axis would be defined as

K(z)=az²+bz+b₀,

wherein the individual parameters a, b or z₀ could also take on a value of zero.

However, with totally general validity, the curvature of a surface is a function of z and of the azimuth angle Φ, wherein the azimuth angle can vary between 0 and 2π. If closed surfaces are being described, the azimuth angle Φ takes on values from 0 to 2π. If only a shell segment rather than a closed mirror surface is being described, the azimuth angle Φ takes on intermediate values between 0 and 2π, for example from π/2 to π. Accordingly, a surface in its most general form can be described by a surface function K(z,Φ) which is dependent on z and the azimuth angle Φ, wherein K(z,Φ) describes the orthogonal distance K(z,Φ) of a point on the surface at the location z as referenced along the z-axis and at an azimuth angle Φ.

The loss of light in an illumination system can now be minimized through the design concept that the collector has at least two adjacent surfaces to receive light, whose respective surface functions K(z,Φ) are adapted to the directional light-emission characteristics of one or more light sources and to the surface area which is to be illuminated in a plane.

A z-axis can be assigned, respectively, to each of the at least two adjacent surfaces. Thus, a first z-axis is assigned to the first surface and a second z-axis is assigned to the second surface. The first and the second z-axis can be identical, in which case the two mirror surface share a common z-axis. However, the first and second z-axes can also differ in their spatial arrangement but lie parallel to each other. As a further variant, it is also conceivable that the first and second z-axes enclose an angle together.

If shell segments are used instead of closed mirror surfaces, the shell segments can be spatially shifted in order to provide different illuminations in the plane in which the field raster elements can be located. If different field raster elements have different pupil raster elements assigned to them in a double-facetted illumination system, it is possible to realize different pupil illuminations through different illuminations of field facets.

In some embodiments, the mirror shells have an axis of symmetry. The symmetry axis can also represent the common symmetry axis for all mirror shells.

Optionally, at least one mirror shell can have one symmetry relative to the symmetry axis. It is possible to have n-fold symmetries, with n being a positive integer. For example, n=2 indicates a twofold symmetry. With a twofold symmetry, a rotation by 180° about the symmetry axis produces identity and a rotation by 360° leads back to the initial position. In a section transverse to the symmetry axis, a shell with twofold symmetry has for example the shape of an ellipse. Alternatively, it is also possible to have for example threefold, fourfold, fivefold, sixfold, sevenfold or eightfold symmetries. In the case of fourfold symmetry, a rotation of 90° leads to identity, with a sixfold symmetry, a rotation of 60° leads to identity, and with an eightfold symmetry, a rotation of 45° leads to identity.

As the nested collector systems always have a minimal collection aperture NAₘᵢₙ to receive light from a light source and thus have a central obscuration, an advantageous way to block scattered light is to provide for the arrangement of a light barrier within the mirror shell that is closest to the common axis.

Optionally, collectors are designed in such a way that more than 50% (e.g., more than 60% and, more than 70%, more than 80%, more than 90%, more than 92%, 95%) of the light gathered by the collector is received by raster elements of a facetted optical element which are arranged in the plane to be illuminated.

In a further aspect of the disclosure, the first mirror shell or the first shell segment, which directs the light from the light source to a first illumination in the plane that is to be illuminated, and the second mirror shell or the second shell segment, which directs the light to a second illumination in the plane, are configured in such a way that the first and the second illumination are spaced apart from each other by a distance which can be larger than 1 mm.

The spacing that results from the arrangement of the mirrors or mirror segments is chosen in particular in such a way that in case of a thermal deformation of the mirror or of the mirror segments, the different illuminated areas will not overlap each other. Furthermore, there is assurance that such an overlap will not occur either for example with a change in the directional light-emission characteristic of the light source.

Optionally, the distance is more than 5 mm, as the thermal deformations resulting from the heating-up of the collector shells or collector shell segments by the light source by about 120° K will, according to experience, lead to a shift or a broadening by about 5 mm of the illumination in the field plane, i.e. the plane in which the first facetted optical element of an illumination system is arranged. The deformations of the collector have no influence on the external shape of the illuminated surface in the plane 114 or on the energy distribution within the illuminated field.

According to a further aspect of the disclosure, an illumination system is put forth in which a large number of raster elements are arranged in a plane of the illumination system within a first area. The illumination system further includes a collector which receives the light of the light source and illuminates a second area in the plane in which the large number of raster elements are arranged. The collector is designed in such a way that to a large extent the second area completely overlaps the first area.

In some embodiments, the first area covers a surface amount B and the second area covers a surface amount A. Optionally, the size of the second area illuminated by the collector is larger than the size of the area in which the first raster elements are arranged, and can be in conformance with the following relationship:

B≦A≦1.2·B, such as

1.05·B≦A≦1.1·B

Due to the fact that the first area with a first surface amount B in which the raster elements are arranged is to a large extent more than covered with illumination, the geometric loss of light is minimized.

In certain embodiments, the collector is designed in such a way that the coverage with light in the plane is an illumination without rotational symmetry, for example an essentially rectangular illumination or in particular a practically square-shaped illumination. This way, the geometric loss of light which amounts to more than 40% in systems of the kind disclosed in US 2003/0043455 A1 can be reduced to a geometric loss of light that is smaller than 30% (e.g., smaller than 20%, and smaller than 10%) as the shape of the illumination is adapted to the shape of the field raster elements.

If the plane in which the facetted optical element with field raster elements is arranged receives an illumination which deviates from rotational symmetry, this has the consequence that the images of the light source which are formed by the field raster elements are astigmatic images, meaning that the images of the light source are distorted and thus not point-shaped. This leads to losses of light. In some embodiments, it is therefore envisioned that the individual field raster elements have an asphericity, for example that they are aspherical mirrors. By taking this measure, the astigmatism of the light source images can be corrected. Optionally, with a large number of field raster elements on the first facetted optical element, the asphericity of each individual field raster element is adapted in such a way that the light source image formed by the field raster element is projected into a pupil plane largely free of distortion. The qualification “largely free of distortion” means that for example the wash-out or the distortion of the light source image with a diameter of e.g. 5 mm in the pupil plane is at most 100 μm, i.e. no more than 2% of the diameter of the light source image, for example in the pupil plane into which the light source image is being projected.

In some embodiments, the first facetted optical element with field raster elements therefore has at least two field raster elements with different asphericities.

In certain embodiments, the shells of the collector are in the form of closed surfaces, for example shells which are arranged inside each other about an axis (HA). An arrangement of this kind is generally called a nested arrangement.

The closed surfaces produce in the plane an essentially rectangular illumination, if the individual collector shells have for example an astigmatic deformation.

In some embodiments which generate an essentially rectangular, optionally square-shaped, illumination in the plane, a part that is not rotationally symmetric is superimposed on the rotationally symmetric part that represents the collector shell, whereby an astigmatic deformation of the aforementioned kind is achieved.

If the plane receives a largely rectangular illumination of this kind, the geometric loss of light is less than 30% (e.g., less than 20%, less than 10%).

As an alternative to the collector that is configured with a closed collector shell, the collector can also consist of individual shell segments.

These shells are arranged in the light path from the light source to the plane to be illuminated essentially in such a way that they take in as much light as possible from the light source and generate a largely rectangular illumination in the plane to be illuminated. Optionally, the illuminations which are produced by the individual shell segments are spaced apart from each other, specifically in such a way that the distance between the illuminations prevents the contributions from individual shell segments to overlap in case of a thermal deformation or a change in the directional emission characteristic of the light source. This distance can be more than 1 mm (e.g., more than 5 mm).

If a collector with shell segments as just described is used in an illumination system which, besides a first facetted optical element with a large number of field raster elements, includes a further facetted optical element with a large number of pupil raster elements, wherein a first multitude of field raster elements is assigned to a first multitude of pupil raster according to a first allocation and a second multitude of field raster elements is assigned to a second multitude of pupil raster according to a second allocation, it is possible to change the allocation between field- and pupil facet elements by setting the shell segments into different positions, whereby a different illumination of the exit pupil can be achieved in the exit pupil of the illumination system.

This, in turn, leads to the result that an arrangement of this kind allows different settings to be selected, as shown for example in U.S. Pat. No. 6,658,084 B2.

With a design of this kind, the illumination setting can be changed without any appreciable loss of light.

As an alternative to setting different illuminations in the exit pupil by bringing shell segments into different positions, it is possible to perform the setting by way of an optical selecting element. If an optical selecting element is used, the collector can be configured as a collector with closed mirror shells. The optical selecting element is optionally arranged in the light path upstream of the first facetted optical element. Different areas of the first facetted element are illuminated, depending on what position the optical element is set to. As the field raster elements on the first facetted optical element are assigned to different pupil raster elements, it is possible by selecting different field raster elements via the optical selecting element to make a selection of pupil raster elements and thereby to establish for example the setting in an exit pupil of the illumination system. The optical selecting element can for example be a roof-shaped mirror element which is mounted with the freedom to rotate about an axis. In a first position, the mirror reflects for example only the light bundle received by the collector, so that the roof-shaped mirror element works as a planar mirror. In a second position of the roof-shaped mirror element, the light bundle falling from the collector onto the roof-shaped mirror element is split into two light bundles which illuminate different areas of the first facetted optical element. Since different field raster elements are assigned to different pupil raster elements, it is thereby possible to select the pupil illumination, for example the setting in the exit pupil.

As an alternative to setting a single optical element into different positions, it is also possible to bring different mirror elements into the light path, which will direct the light into different areas of the field facet mirror. In this way, too, it is possible to realize different setting selections.

As an alternative to deforming the mirror shells of the collector or to configuring the collector with mirror segments that are arranged in or close to the plane in which the field raster elements of a first facetted optical element are located and are producing an essentially rectangular illumination, it can be envisioned in some embodiment, that the collector has individual collector shells which, in a plane lying upstream of the plane in which the facetted optical element is arranged, generate an essentially ring-shaped illumination. This essentially ring-shaped illumination can be transformed into an essentially rectangular illumination by inserting an optical element in the light path upstream of the plane in which the ring-shaped illumination is being formed and in which the facetted optical element is arranged.

In some embodiments, an optical element of this kind is for example an aspherical mirror.

As an alternative to this, as described in US2002/0186811 A1, a diffraction grating with optical power can be set up in the light path from the collector to the plane in which the facetted optical element is arranged. Due to the optical power of the grating, the essentially ring-shaped illumination is transformed into an essentially rectangular illumination in the plane in which the facetted optical element with field raster elements is arranged. Furthermore, the filter performs at the same time a spectral filtering function as described e.g. in US2002/0186811 A1, so that only light of the usable wavelength of e.g. 13.5 nm is present in the illumination system which lies in the light path downstream of the grating. The term “light of a usable wavelength” in the present context means light of the wavelength which in a microlithography projection exposure apparatus projects the image of an illuminated object in the object plane, for example a reticle, into the image plane, for example via a projection objective.

An illumination system according to the disclosure can include a light source with a largely isotropic directional light-emission characteristic. In isotropically radiating light sources, i.e. light sources which radiate uniform amounts of energy in all spatial directions, the collector according to the disclosure can achieve the result that equal angular segments received from the light source are projected onto equally large surface areas in a plane, for example in the plane to be illuminated and that these areas are irradiated with a uniform energy density.

As is self-evident for those of ordinary knowledge in the pertinent art, the multitude of individual measures mentioned in the foregoing description can be combined with each other.

### BRIEF DESCRIPTION OF THE DRAWINGS

The disclosure will hereinafter be described in detail with reference to the drawings, wherein:

FIG. 1 shows an EUV projection exposure apparatus with a collector including at least two mirror shells, which illuminates a plane in or near a facetted optical element;

FIG. 2 illustrates the illumination in or near the plane in which the facetted optical element is arranged, as obtained with a collector of the existing state of the art;

FIG. 3 illustrates an essentially square-shaped illumination in or near the plane in which the facetted optical element is arranged;

FIGS. 4a-4d illustrate how the illumination in a plane is affected by the deformation of closed mirror surfaces;

FIG. 5a shows a sectional view along the z-axis in the y/z-plane through a shell of a collector in which the mirror shell has been deformed in order to obtain an essentially square-shaped illumination;

FIG. 5b shows a three-dimensional representation of a system with two surfaces and with two z-axes relative to which the two surfaces are defined;

FIG. 5c shows a three-dimensional representation of a system with three surfaces and with two z-axes relative to which the surfaces are defined, wherein two surfaces adjoin each other with a discontinuity in the z-direction;

FIG. 6 is an illustration of the principle of an illumination system that serves to produce an essentially square-shaped illumination via an aspherical mirror;

FIG. 7 is an illustration of the principle of producing an essentially square-shaped illumination in a plane via a diffraction grating with optical power;

FIGS. 8a-8c illustrate the configuration of a collector of the existing state of the art, wherein the individual illuminations in the plane essentially adjoin each other;

FIGS. 9a-9c illustrate the configuration of a collector where the illuminations in the plane are spaced apart from each other and wherein the field honeycomb cells have a rectangular shape;

FIG. 9d represents a field honeycomb plate in which the field honeycomb cells have an arcuate shape;

FIGS. 10a-10b2 represent the configuration of a collector with shell segments serving to produce an essentially rectangular illumination in the plane;

FIGS. 11a-11b represent the configuration of a collector serving to illuminate different places in the plane;

FIGS. 12a-12b represent different illuminations that are due to a change in the assignment of field facets to pupil facets; and

FIGS. 13a-13e represent different illuminations of the facetted optical element with field facets and the resulting different pupil illuminations achieved via an optical selecting element.

### DETAILED DESCRIPTION OF THE DISCLOSURE

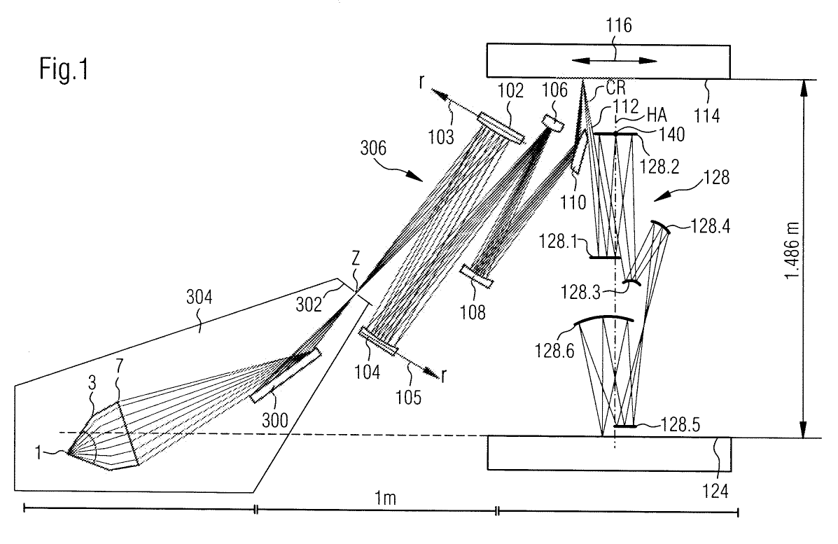

FIG. 1 illustrates the principle of a projection exposure apparatus in which the disclosure finds application, serving for example for the manufacture of microelectronic components. The projection exposure apparatus includes a light source or an intermediate image of a light source 1. The light emitted by the light source 1 is gathered by a collector 3 which includes a large number of mirror shells. The collector in the illustrated projection exposure apparatus is followed by a further optical element which is realized here as a planar mirror 300. The rays arriving on the planar mirror from the collector are reflected into a different direction, in particular as a way to make design space available for the mechanical and optical components in an object plane 114 in which the reticle stage is arranged. The object plane 114 is also referred to as field plane. The planar mirror 300 can also be designed as a diffractive spectral filter element. A spectral filter element of this kind is for example a diffraction grating of the kind disclosed in US 2002/0186811 A1. Together with the aperture stop 302 in the vicinity of the intermediate image Z of the light source 1, a grating element of this kind can keep undesirable radiation, for example with wavelengths significantly longer than the desired wavelength, from entering into the part of the illumination system that lies downstream of the aperture stop 302. In particular, radiation with wavelengths different from the operating wavelength of for example 13.5 nm of EUV microlithography projection apparatus can be barred from entering into the optical system lying downstream of the aperture stop 302.

By arranging a valve in the vicinity of the intermediate focus Z, the aperture stop 302 can also serve to spatially separate the space 304 which contains the light source as well as the collector 3 and the planar mirror 300 which is configured as a diffraction grating from the illumination system 306 which follows downstream. The two spaces can also be separated by pressure levels. Will two spaces through pressure-based separation become possible. With a spatial or a pressure-based separation, one can prevent contaminations originating from the light source 1 from penetrating into the illumination system downstream of the aperture stop 302.

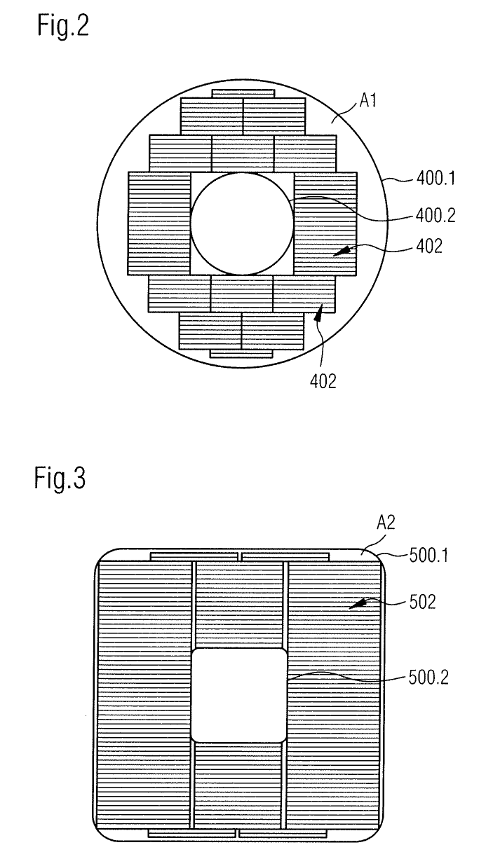

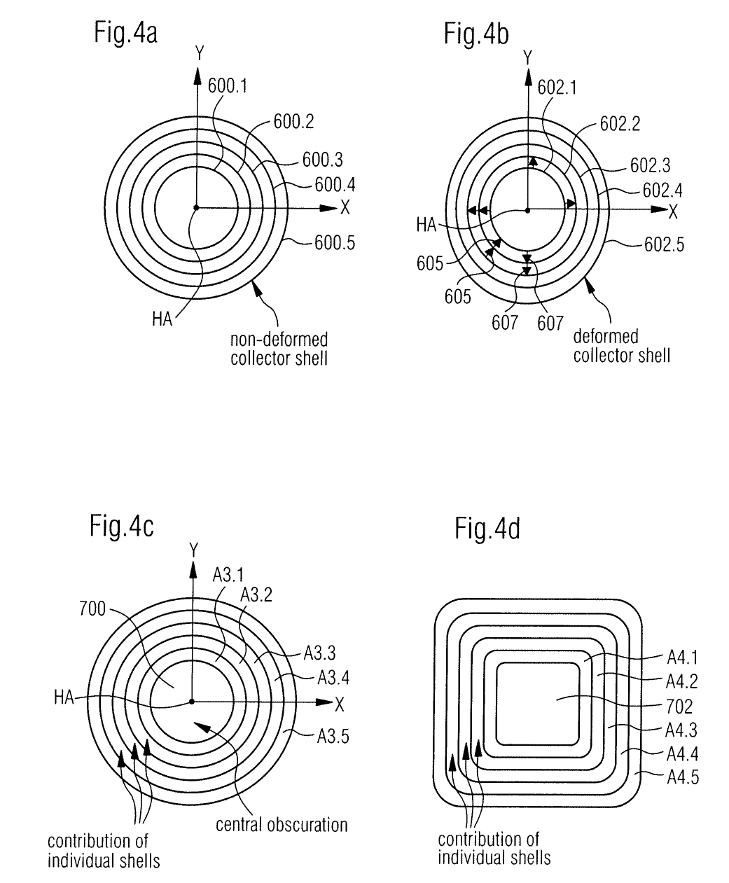

The light that has been gathered by the collector 3 and deflected into a new direction by way of the planar mirror 300 is directed to a mirror 102 with a large number of first raster elements, so-called field facets or field raster elements. In the present case, the first raster elements are of a planar design. The illumination in the plane 103 in or near the facetted mirror 102 can be essentially circular-shaped as in the state-of-the-art arrangement shown in FIG. 2, wherein each of the mirror shells of the collector illuminates a circular ring-shaped area which in essence borders directly on adjacent circular ring-shaped areas in the plane 103. An illumination of this kind for a state-of-the-art collector as described in US 2003/0043455A1 is illustrated in FIG. 2. As an alternative, the disclosure offers a collector which has mirror shells that are not rotationally symmetric but are for example deformed, resulting in a not rotationally symmetric but for example rectangular illumination in the plane in which the first optical element 102 with field raster elements is arranged. An illumination of this kind is shown for example in FIG. 3 or FIG. 4d. A collector with deformed mirror shells is shown for example in FIG. 4b.

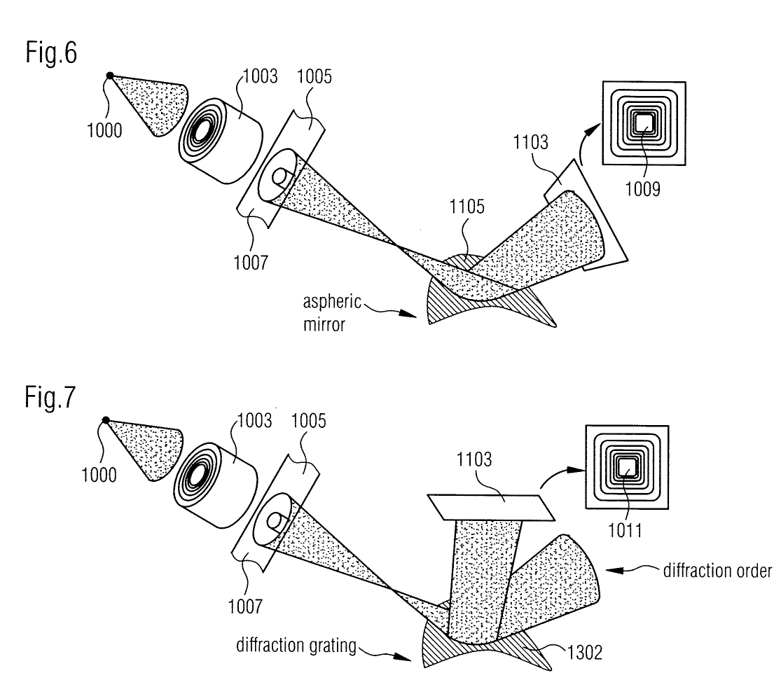

As an alternative to a collector with mirror shells that are not rotationally symmetric it is also possible to generate the essentially rectangular illumination with a collector with rotationally symmetric mirror shells in an arrangement where the shaping of the illumination as described in the context of FIGS. 6 and 7 is performed by an optical element, such as for example the optical element 300, which is arranged in the light path downstream of the collector. This is accomplished for example by giving the mirror 300 an aspherical configuration, as shown in FIG. 6.

The illumination system is a double-facetted illumination system as disclosed for example in U.S. Pat. No. 6,198,793 B1, which includes a first optical element 102 with field raster elements and a second optical element 104 with pupil raster elements (not shown in the drawing). The latter is arranged in or near a further plane which is also referred to as pupil plane 105.

The facetted optical element 102 with field raster elements divides the light arriving from the light source into a plurality of light bundles, wherein exactly one pupil raster element of the second optical element is assigned to each field raster element. As shown in US 2002/0136351 A1, this assignment correlation determines the illumination in the exit pupil of the illumination system. The exit pupil of the illumination system is normally defined by the point where the principal ray (CR) through the central field point in the field to be illuminated in the object plane 114 intersects the optical axis HA of the projection objective. This exit pupil is identified in the present example by the reference numeral 140. The optical elements 106, 108, 110 essentially serve the purpose of forming the field in the object plane 114. The field in the object plane 114 is normally a segment of a circular arc. Arranged in the object plane 114 is a reticle (not shown) which is illuminated via the illumination device 306 and whose image is projected via the projection objective 128 into an image plane 124. If the system is a scanning system, the reticle arranged in the object plane 114 is movable in the direction 116. The exit pupil of the illumination system coincides with the entry pupil of the projection objective 128.

In some embodiments (not shown), the field raster elements or the field facets can have the shape of the field that is to be illuminated in the object plane and can thereby determine the shape of the field in the object plane. An illumination system of this kind has been disclosed for example in U.S. Pat. No. 6,195,201. If the field in the object plane has for example the shape of a circular arc, the facets will likewise by arc-shaped.

As shown in FIG. 1, microlithography projection exposure apparatus for use in the field of EUV lithography with an operating wavelength of e.g. 13.5 nm are of an entirely reflective design, meaning that the field raster elements are configured as field facet mirrors and the pupil raster elements are configured as pupil facet mirrors.

As the illumination in the plane in which the field raster elements are arranged is not rotationally symmetric but for example rectangular, the light source images projected into a pupil plane, for example into the exit pupil, are not shaped in conformance to the object, but are distorted. This can be compensated through aspherical field raster elements (not shown). Different field raster elements of the first optical element in this case optionally have different asphericities, depending on the asphericity desired in order to compensate the distortion in the image of the light source that is caused by the illumination.

The projection objective 128 in the illustrated embodiment has six mirrors 128.1, 128.2, 128.3, 128.4, 128.5 and 128.6 and its configuration is the same as shown for example in U.S. Pat. No. 6,600,552.

The projection objective 128 projects an image of the reticle (not shown in the drawing) which is located in the object plane 114 into the image plane 124.

FIG. 2 shows the illumination distribution in the plane 103 of the first optical element 102 of FIG. 1. The total area A1 illuminated by the collector is delimited by a border 400.1 which is due to the outermost mirror shell and by an inner border 400.2 which is due to the innermost aperture element.

As can be clearly seen, with the mirror shells being in essence rotationally symmetric, the illumination in the plane 103 in FIG. 1 has a circular shape. One further recognizes the field facets 402 of the first facetted optical element 102 of FIG. 1. The individual field facets 402 are mirror elements which are arranged on a carrier. The field facets 402 in the illustrated embodiment have an essentially rectangular shape. Field facets of another shape, for example of an arcuate shape, are also possible, as described above.

As can be concluded from FIG. 2, the geometric loss of light of the illuminated area in comparison to the area in which the field facets are arranged is about 40%.

To reduce the geometric loss of light, it is envisioned according to the disclosure to adapt the illumination in the plane 103 of FIG. 1 to the rectangular shape of the field facets 502. An illumination in the field plane 103 of FIG. 1 which has been optimized in this manner is shown in FIG. 3. The essentially rectangular illumination A2 in the plane 103 of FIG. 1 has again an outer border 500.1 and an inner border 500.2. The field facets in FIG. 3 are identified by the reference numeral 502.

With an illumination in the plane 103 which is essentially rectangular, in particular nearly square-shaped, as shown in FIG. 3, the geometric loss of light, i.e. the portion of the light that is not received by the field facets, is reduced to less than 10% if the field facets are of rectangular configuration as illustrated.

An essentially rectangular illumination in the plane 103 can be achieved in many different ways. In a first configuration as shown in FIGS. 4a to 4d, the collector 3 of FIG. 1 has closed mirror surfaces which are arranged inside each other around an axis of rotation.

With a specifically targeted deformation of the individual collector shells, it is possible to achieve this kind of an essentially rectangular illumination. In FIG. 4b, the inward-directed deformation of the individual collector shells 602.1, 602.2, 602.3, 602.4 and 602.5, i.e. the compression towards the optical axis HA, is identified by arrows 605, and the outward-directed deformation resulting in a local displacement away from the optical axis HA is identified by arrows 607. The arrows 605 and 607 are oriented perpendicular to the deformed collector surface. The following is an explanation of this concept.

FIG. 4c shows the illumination in the plane 103 for a collector with a large number of non-deformed mirror shells 600.1, 600.2, 600.3, 600.4, 600.5 which are rotationally symmetric relative to a common axis of rotation HA. The common axis of rotation is at the same time the symmetry axis. As shown in FIG. 4c, the illumination in the plane 103 of FIG. 1 is distinguished by a central obscuration 700 and individual illuminations A3.1, A3.2, A3.3, A3.4, A3.5, which are assigned, respectively, to the mirror shells 600.1, 600.2, 600.3, 600.4 and 600.5 of the collector shown in FIG. 4a with mirror shells which are in essence rotationally symmetric relative to the axis HA. The illuminations A3.1, A3.2, A3.3, A3.4, and A3.5 are again of circular shape and essentially adjoin each other directly with a small gap. In this case, an illumination of the kind shown in FIG. 2 is achieved in the plane 103 where the field facets of the first optical element are arranged.

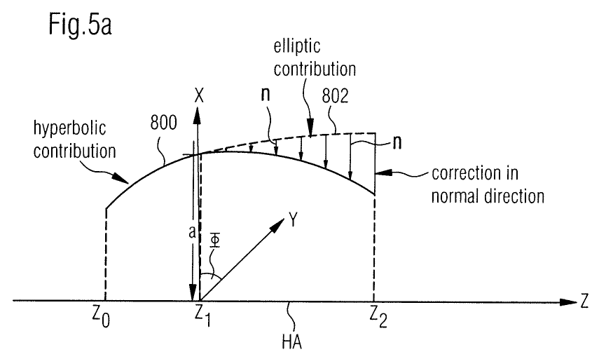

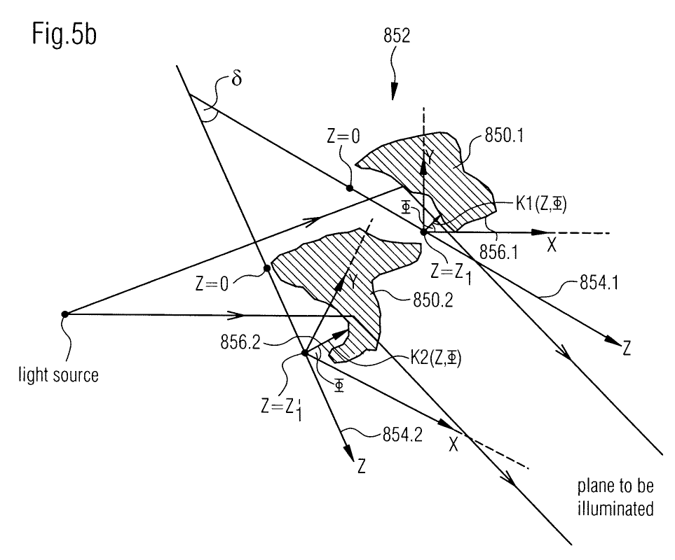

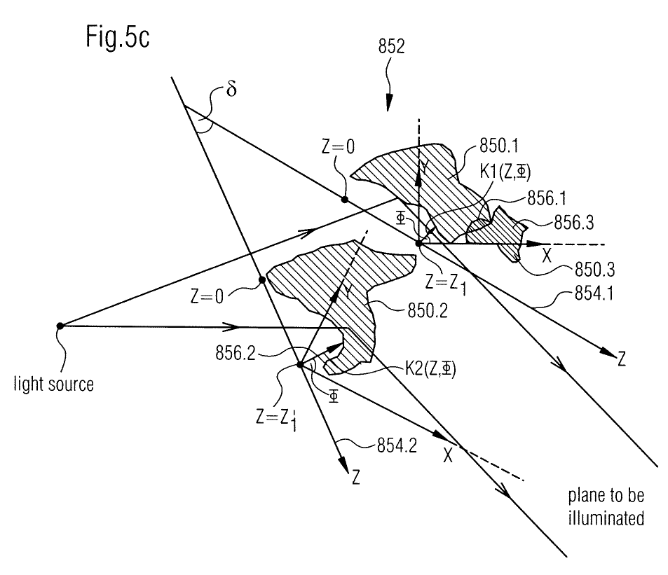

If the individual shells 602.1, 602.2, 602.3, 602.4 and 602.5 are subjected to a deformation as illustrated in FIG. 4b and described in more detail in the following, an illumination as shown in FIG. 4d is obtained in the plane 103 of FIG. 1. The illumination as shown in FIG. 4d is essentially rectangular-shaped and has a central obscuration 702 and individual illuminations A4.1, A4.2, A4.3, A4.4, A4.5 belonging to the respective deformed mirror shells of FIG. 4b. A square-shaped illumination as illustrated in FIG. 4d where it is generated through deformation of closed mirror shells can be achieved for example through a design of a collector shell according to the following description which refers to FIG. 5a. The mirror shell of FIG. 5a is shown in sectional view along the axis HA. The collector shell is composed of a basic body that is rotationally symmetric relative to the optical axis HA with a hyperbolic first mirror segment and an elliptic second mirror segment adjoining the hyperbolic first mirror segment. The hyperbolic first mirror segment 800 is generated by rotating a hyperbola about the optical axis HA. The rotationally symmetric elliptic second mirror segment is indicated in FIG. 5 as a dash-dotted line and identified by the reference numeral 802. The rotationally symmetric mirror segment is likewise obtained by rotation about the axis HA.

The two portions of the basic, rotationally symmetric body, namely the hyperbolic first portion 800 and the elliptic second portion 802, are described by the following equation:

$$z ( h , k , ρ , {z}_{0} ) = \frac{ρ {h}^{2}}{1 + \sqrt{1 - ( 1 + k ) {( h ρ )}^{2}}} + {z}_{0}$$

wherein k stands for the conical constant and ρ stands for the curvature at the apex. These parameters as well as the z-limits z₁ and z₂ of the surfaces are listed in the following Table 1.

TABLE 1
Data for a rotationally symmetric mirror shell

| | k | ρ [mm⁻¹] | z₀ [mm] | z₁ [mm] | z₂ [mm] |
|---|---|---|---|---|---|
| Hyperboloid | −1.26602359 | 0.04479337 | −10.505 | 78.374 | 159.801 |
| Ellipsoid | −0.96875135 | 0.03730042 | −202.361 | 159.801 | 275.000 |

The collector shell represented by the foregoing Table 1 generates a ring-shaped illumination in the far field, as shown in FIG. 4c.

A square-shaped illumination of the far field is obtained through a specifically targeted deviation of the elliptic portion from rotational symmetry which can be described as a correction in the normal direction of the basic, rotationally symmetric body. In the present context, the term “normal direction” means the direction which is oriented perpendicular to the mirror shell at the location z. A normal vector n according to this definition is illustrated in FIG. 5a for different locations z.

Also shown in FIG. 5a is the x-y-z coordinate system and the cylindrical coordinate system r, Φ which is used to describe the deviation from rotational symmetry that leads to the essentially rectangular illumination in the plane 103. The not rotationally symmetric portion, i.e. the correction applied to the elliptic portion, is described by the following function, expressed in cylindrical coordinates:

$$f ( z , Φ , a ) = a \frac{z - {z}_{1}}{{z}_{2} - {z}_{1}} sin ( 4 ( Φ - \frac{Π}{8} ) ) ,$$

wherein the normal vector n is defined for every point of the basic, rotationally symmetric body. Furthermore, Φ stands for the azimuth angle in a plane that extends orthogonal to the z-axis, with the latter being the rotational axis for the bodies of rotation. The quantity f(z,Φ,a), which represents the magnitude of the correction, increases linearly with z in the illustrated embodiment and attains its maximum at the end of the collector. The quantity a in the present context represents a constant. FIG. 4d schematically illustrates the illumination in the plane 103 of FIG. 1.

As an alternative possibility, the not rotationally symmetric portion can be either added to or subtracted from the hyperbolic first mirror segment 800 (not shown in the drawing) or both mirror segments.

As a further alternative, a mirror can be composed of a plurality of parts, wherein the mirror has rotationally symmetric segments and not rotationally symmetric segments as described above. The segments can adjoin each other smoothly or discontinuously. In the former case, for example a single-part mirror is formed, and in the latter case a multi-part mirror.

In some embodiments, a collector 852 with two surfaces 850.1, 850.2 as shown in FIG. 5b with at least one deformed mirror surface for generating any desired illumination can be obtained in the way which will be described next.

Each of the two surfaces 850.1, 850.2 of the collector is defined, respectively, by an axis 854.1, 854.2, and by a surface function which is referenced relative to the respective axis. In the present case, a respective z-axis 854.1, 854.2 is considered as the axis of reference for each of the surfaces. A respective x-y plane 856.1, 856.2 which can be defined in polar coordinates, i.e. a radius r and an azimuth angle Φ, extends orthogonal to the z-axis 854.1, 854.2 of the respective surface. As a totally general statement, the surface function K1, K2 of each surface 850.1, 850.2 is a function of the z-coordinate and the azimuth angle Φ of the respective surface, wherein the azimuth angle Φ can vary between 0 and 2π. If closed surfaces are being described, the azimuth angle Φ takes on values from 0 to 2π. If, as shown here, only a mirror segment is being described, rather than a closed mirror surface, the azimuth angle Φ takes on values between 0 and 2π, for example from π/2 to π. Accordingly, a surface in its most general form can be described by a curvature K(z,Φ) which depends on z and the azimuth angle Φ. The result in the present case is a surface function K1(z,Φ) for the first surface 850.1 and K2(z,Φ) for the second surface 850.2.

Of course, collectors are also conceivable which have more than two surfaces, for example three or four surfaces.

Also, as shown in FIG. 5c, it is possible by combining the surfaces shown in FIG. 5b with the feature of discontinuous mirror surfaces to produce collectors which have two surfaces 850.1, 850.2 which adjoin each other discontinuously in the z-direction and which are defined by the axis 854.1 as their z-axis. In addition to the multi-part surface which consists of two surfaces 850.1, 850.3 adjoining each other discontinuously, the collector can in addition include the single-part surface 850.2. The same reference numerals as in FIG. 5b are also used in FIG. 5c.

Each of the at least two adjoining surfaces in the illustrated embodiment has a respective local z-axis assigned to it. Thus, a first z-axis 860.1 is assigned to the first surface, and a second z-axis 860.2 is assigned to the second surface. In the present example, the first z-axis 860.1 and the second z-axis 860.2 enclose an angle δ together.

As an alternative to the specifically targeted deformation of the collector shells as a way to generate the essentially rectangular, but optionally square-shaped illumination in the plane 103 in which the first facetted optical element is arranged, it is possible, as shown in FIG. 6, to arrange an aspherical mirror 1105 in the light path from the light source 1000 to the plane 1103 in the vicinity of the facetted optical element. The aspherical mirror 1300 transforms an essentially ring-shaped illumination 1007 generated in a plane 1005 by the collector 1003 with a large number of mirror shells into an essentially rectangular illumination 1009 in the plane 1103.

In a projection system of the kind shown in FIG. 1, this can be achieved for example by designing the mirror 300 as an aspherical mirror.

In some embodiments, as shown in FIG. 7, an essentially ring-shaped illumination 1007 in a plane 1005 immediately beside the collector 1003 is transformed via the diffraction grating 1302 with optical power into an essentially rectangular, optionally square-shaped illumination 1011 in a plane 1103 in which the first optical element with field raster elements is located. At the diffraction grating 1302 the light is subjected to first-order diffraction. The light proceeding under the zero-order of diffraction, which also contains components with a wavelength other than the useful wavelength, can be stopped by a light barrier from entering into the illumination system. The useful wavelength is the wavelength which is utilized to project an image of an object plane into an image in an image plane in a microlithography projection exposure apparatus. A useful wavelength in EUV lithography is for example 13.5 nm.

In the embodiment shown in FIG. 7, identical components as in FIG. 6 are identified by the same reference numerals. In order to achieve the effect illustrated in FIG. 7, the mirror 300 in an illumination system according to FIG. 1 can be designed as a diffraction grating with optical power.

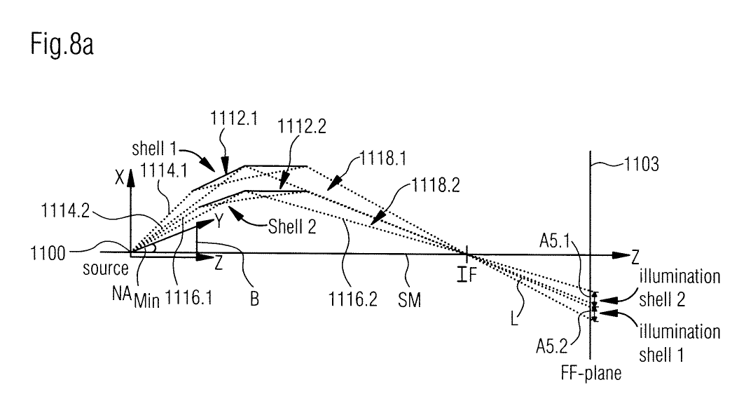

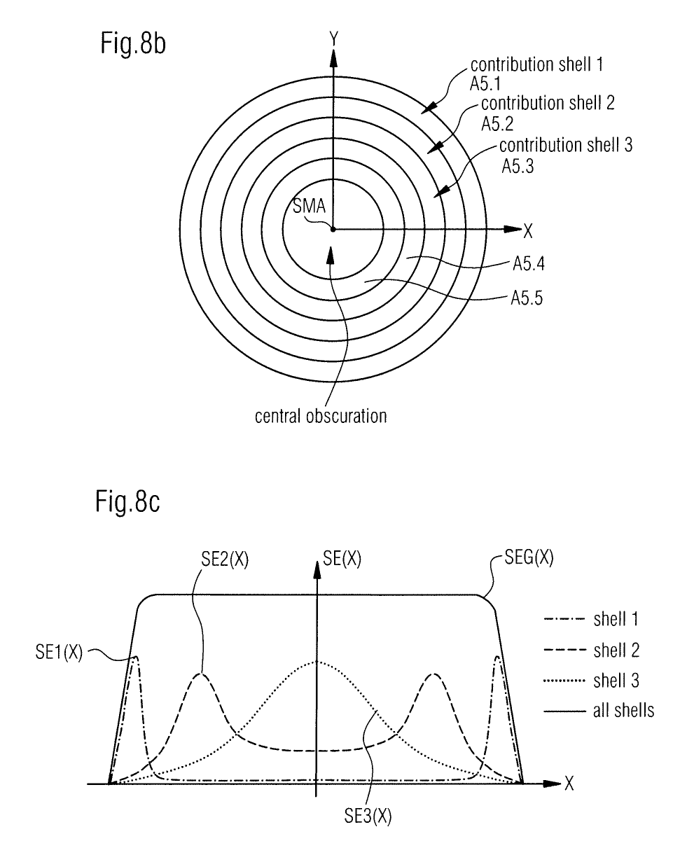

A further problem with collectors of the kind that are used in the current state of the art can be seen in the fact that the illuminations of the individual mirror shells are essentially directly contiguous to each other. A collector of this kind which is also described in US 2003/0043455 A1 is shown in FIG. 8a in a sectional view in the x-z plane. The light source is identified with the reference numeral 1100, the first shell with the reference numeral 1112.1, and the second shell with the reference numeral 1112.2. Also indicated in the drawing are the marginal rays 1114.1, 1114.2, 1116.1, 1116.2 of the first ray bundle 1118.1 which is received by the first collector shell 1112.1, and of the second ray bundle 1118.2 which is received by the second collector shell 1112.2. The marginal ray 1116.2 of the second mirror shell 1112.2, which is closest to the symmetry axis SM relative to which the closed shells are rotationally symmetric, determines the minimal collection aperture NA_{Min} that can still be received by the collector shown in FIG. 8a from the light source 1100. Light with an even smaller angle cannot be received by the collector. As a way to prevent the passage of scattered light through the collector, a light barrier B is arranged to the inside of the second mirror shell 1112.2 which is closest to the symmetry axis. The two ray bundles 1118.1, 1118.2 are reflected at the shells 1112.1, 1112.2 and illuminate the areas A5.1 and A5.2 in the plane 1103 which essentially corresponds to the plane 103 in FIG. 1.

As can be clearly seen in the x-z section in FIG. 8a, the two illuminations in the plane 1103 are essentially bordering directly on each other. The small gap of less than 1 mm which exists between the illuminations is only the result of the finite thickness of the individual reflector shells, so that the first and the second illumination are separated by a gap of less than 1 mm in the plane 1103. The illumination which a system according to FIG. 8a produces in the plane 1103 with an x-y orientation is illustrated in FIG. 8b.

FIG. 8b clearly shows the individual ring segments A5.1, A5.2, A5.3, A5.4, and A5.5. These individual ring segments in essence adjoin each other directly in the plane 1103. FIG. 8b also shows the symmetry axis of the illumination SMA.

FIG. 8a illustrates only the first and second mirror shells, whereas FIG. 8b also shows the illumination of the further mirror shells, i.e. of the third, fourth and fifth shell.

FIG. 8c shows for the first, second and third shell the energy SE(x) integrated over the scan path, i.e. in the y-direction, for the first shell with the illumination A5.1, the second shell with the illumination A5.2 and the third shell with the illumination A5.3. The scan-integrated energy for the first shell is identified by the reference symbol SE1, for the second shell by the reference symbol SE2, and for the third shell by the reference symbol SE3. The scan-integrated energy is obtained, as explained above, by integration of the contributions of the individual mirror shells along the y-axis of the ring field that is to be illuminated in the field plane 114. In FIG. 1, the local coordinate system in the field plane is indicated. As can be concluded from FIG. 1, the y-direction, which is also the direction of integration, is the scanning direction for the ring-field projection exposure apparatus shown in FIG. 1, which is operated in the scanning mode.

As is apparent from FIG. 8c, while the overall sum profile of the scan-integrated energy SE(x) is largely homogeneous, the same is not true for the contributions of the individual mirror shells.

This has the consequence that in case of a thermal deformation of individual mirror shells or if there is a change in the reflectivity of an individual mirror shell, the scan-integrated uniformity will vary very strongly. In order to solve this problem, it is proposed under a further aspect of the disclosure to interpose a non-illuminated area between the area illuminated by the first shell and the area illuminated by the second shell. In other words, the first illumination is spaced apart from the second illumination, so that even with a thermal deformation of the mirror shells, the illuminations will not overlap. This makes it possible to ensure a largely homogeneous scan-integrated uniformity.

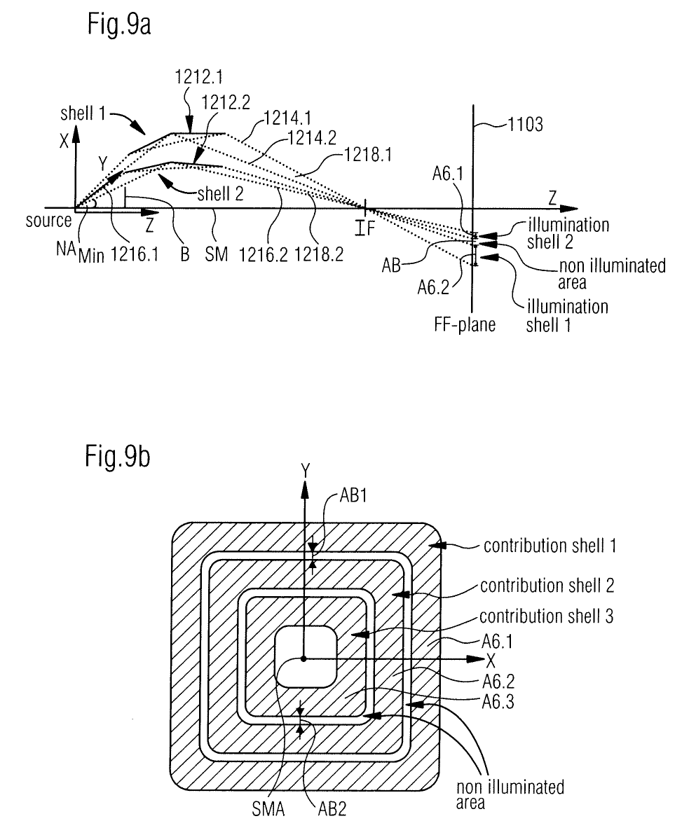

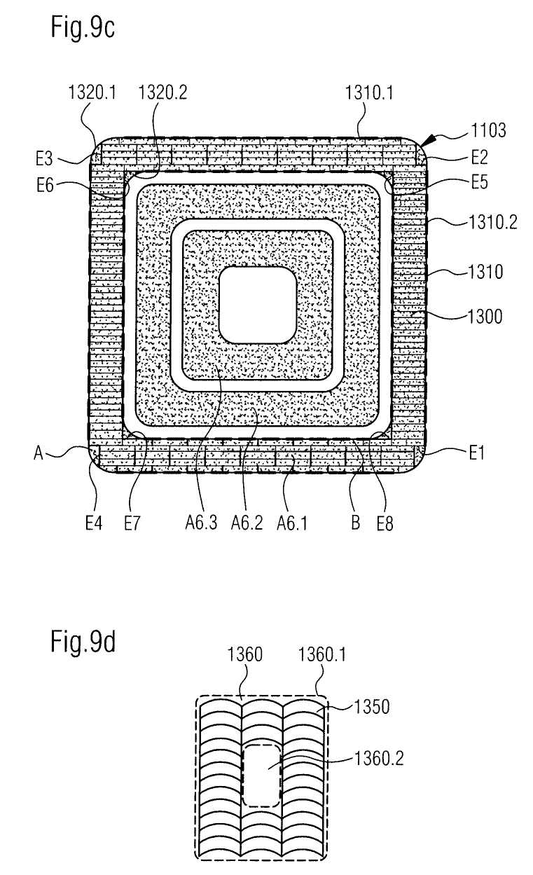

As a sectional drawing in an x-z plane, FIG. 9a again shows a system in which the areas A6.1 and A6.2 illuminated, respectively, by the first mirror shell 1212.1 and the second mirror shell 1212.2 are separated by a distance AB. Components that are identical to those in FIG. 8a are identified by the reference numerals of FIG. 8a raised by 100. Optionally, the shells 1212.1, 1212.2 are deformed collector shells which not only produce a gap between the illuminated areas in the plane 1102, but also a substantially rectangular shape of the illumination, as shown in FIG. 9b. Likewise, the minimal collection aperture NA_{Min} is indicated again which is still received by the innermost collector shell, which is in this case the second collector shell 1212.2. Further illustrated is the light barrier B which prevents the passage of scattered light. The drawing also shows the z-axis which in the present embodiment simultaneously represents the common symmetry axis for the closed, not rotationally symmetric mirror shells.

FIG. 9b shows the illumination for a total of three mirror shells, i.e. a first shell, a second shell and a third shell. The area illuminated by the first shell is identified as A6.1, the area illuminated by the second shell is identified as A6.2, and the area illuminated by the third shell is identified as A6.3. The areas illuminated, respectively, by the first mirror shell A61 and by the second mirror shell A6.2 are separated by a distance AB1, and the areas illuminated, respectively, by the second mirror shell A62 and by the third mirror shell A6.3 are separated by a non-illuminated area AB2. The gaps AB1 and AB2 are dimensioned so that when the mirror shells change their shapes for example due to a thermal deformation, the illuminated areas in the plane 1103 in which the first facetted optical element with field facets is arranged are not overlapping each other. The illumination has a symmetry axis SMA. In the present case, the symmetry axis SMA of the illumination is an axis of fourfold symmetry.

FIG. 9c shows the arrangement of the field facets in the illumination A6.1 produced by the first mirror shell in the plane 1103. The individual field facets are identified with reference numerals 1300. All of the field honeycomb cells 1300 lie within the area of the illumination A6.1 which is enclosed by the solid lines 1320.1 and 1320.2. The field honeycomb cells or field facets 1300 lying in the illumination A6.1 are completely filled by the illumination. In the present case the illumination is largely rectangular, and the shape of the field facets is rectangular. The field facets lie in an area 1310 which is enclosed by the dash-dotted lines 1310.1, 1310.2. This area encloses an area B. The illumination, i.e. the area A6.1 illuminated by the first mirror shell covers a surface area A. As can be concluded from FIG. 9c for the illumination produced by the first mirror shell, the geometric loss of light is minimized, if the area 1310 in which the field facets are located largely coincides with the area A6.1 which is illuminated for example by the first collector shell. As can be seen in FIG. 9c, only the corner area E1, E2, E3, E4, E5, E6, E7, E8 of the illumination A6.1 are areas in which no raster elements are arranged. The area 1310 can be completely illuminated, but the surface area covered by the illumination should be no more than 1.2 times as large as the surface B of the area 1310, so that the surface B of the area 1310 and the surface A of the illumination A6.1 produced for example by the first mirror shell meet the condition:

B≦A≦1.2·B, such as

1.05·B≦A≦1.1·B

The forgoing example has been described in detail for the illumination of an area illuminated by a first mirror shell of a nested collector. Of course, an individual of ordinary skill in the pertinent art can, without any inventive activity of his own, transfer the same concept also to the other mirror shells, and further to the entire area in the plane that is illuminated by all of the mirror shells. For the total area, for example the relationship given above applies to the summation of the contributions of the individual mirror shells. The illumination produced by the second and the third mirror shell is identified by the reference numerals A6.2 and A6.3, respectively.

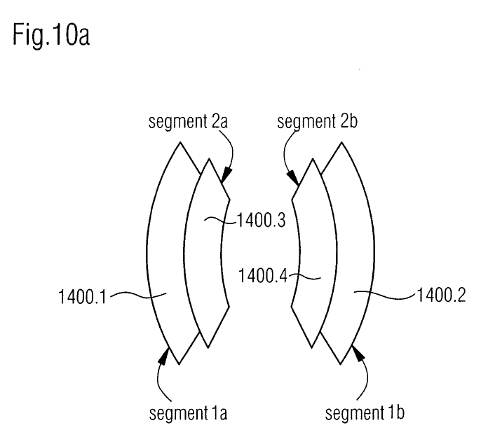

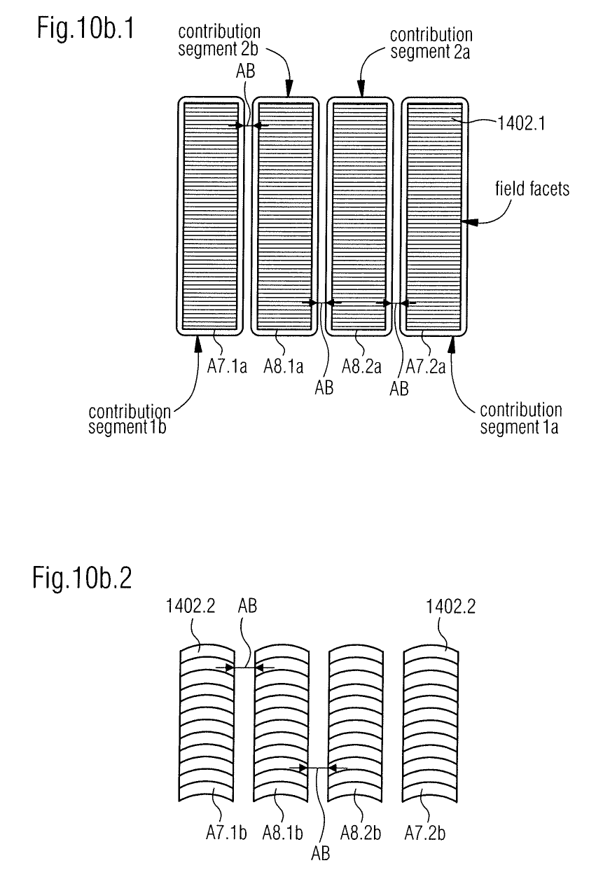

FIG. 9d shows a first optical element with field raster elements whose shape is adapted to the illuminated field, and it shows the illumination of a field raster element of this kind. As described above, field raster elements or field facets that have the shape of the field that is to be illuminated in the object plane have been disclosed for example in U.S. Pat. No. 6,195,201. The field in the object plane in U.S. Pat. No. 6,195,201 has the shape of a circular arc, so that the individual field facets are likewise of arcuate shape. The individual arcuate field facets are arranged in an area 1360 which is enclosed by the dash-dotted lines 1360.1 and 1360.2. As the arcuate field facets 1350 in this embodiment are arranged in a largely rectangular area, the illumination A6a.1 produced by the collector in the plane in which the field facet elements are arranged is likewise largely rectangular. FIG. 9d shows the illumination produced by a collector with a closed surface which has only one mirror shell, without thereby implying a limitation to one mirror shell. Of course, it is also possible to use collectors with a plurality of shells, as has been described above in the case of rectangular field facets. It is further self-evident that other arrangements of the arcuate elements are also possible, for example in blocks as shown in FIG. 10b2 for rectangular honeycomb cells or field facets.

In illumination systems or projection exposure apparatus of a reflective design for use in microlithography at wavelengths ≦193 nm, in particular ≦100 nm, and especially in the EUV range of ≦15 nm, the field facets are likewise designed with reflective optics, for example as individual facet mirrors. However, the projection exposure apparatus shown in FIG. 1 for lithography in the EUV range of wavelengths represents only an example and imposes no limitation of any kind on the disclosure.

As an alternative to an embodiment of the disclosure with closed mirror shells, it is also possible to build a collector with shell segments alone. This is shown in FIG. 10a, and the illumination which the shell segments produce in the plane in which the first facetted optical element with field facets or field raster elements is arranged is shown in FIG. 10b.

The first shell- or mirror segment is identified by the reference numerals 1400.1, 1400.2, the second shell- or mirror segment by the reference numerals 1400.3 and 1400.4. FIGS. 10b1 and 10b2 show the four illuminated areas in the plane in which the first facetted element with field raster elements is arranged. FIG. 10b1 shows an embodiment with rectangular field facets. The illumination produced by the mirror segments 1400.1 and 1400.2 in the plane 103 is identified here with A7.1a and A7.2a. The illuminations A8.1a and A8.2a are those that were produced via the mirror segments 1400.3 and 1400.4. As is clearly evident from the drawing, the four areas A7.1a, A7.2a, A7.3a and A7.4a that are to be illuminated have a distance AB from each other. In FIG. 10b.1, all of the rectangular field facets 1402.1 are arranged inside the illuminated areas A7.1a, A7.2a, A8.1a and A8.2a. FIG. 10b.2 shows an embodiment of the disclosure in which the field facets 1402.2 are designed with an arcuate shape. The areas illuminated by the mirror segments 1400.1 and 1400.2 are identified as A7.1b, A7.2b, A8.1b, A8.2b. The distances between the illuminations are again identified as AB.

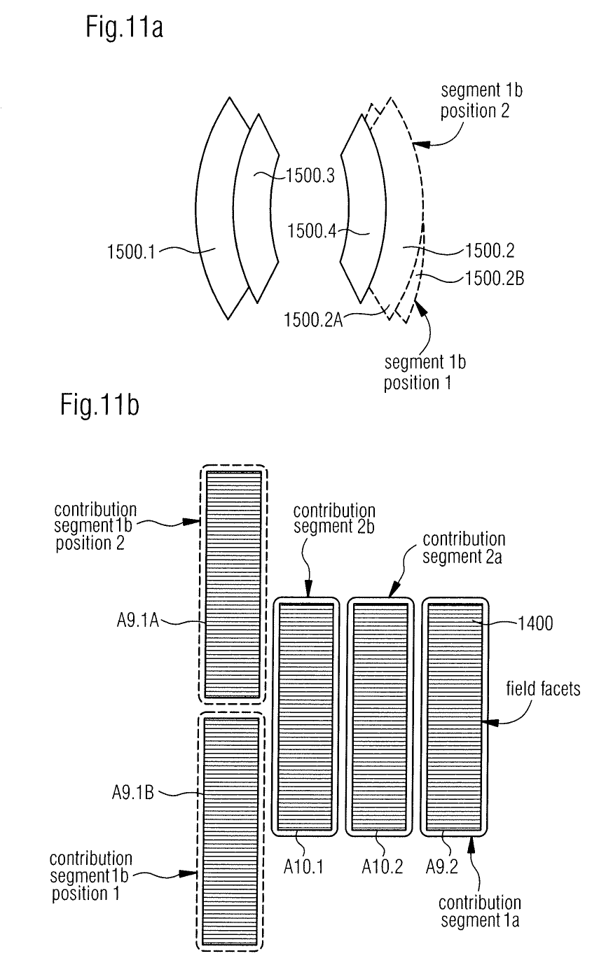

In some embodiments, as illustrated in FIGS. 11a and 11b, it is possible that for example one shell is rotatably mounted, so that the collector can be operated in two states, i.e. in a first and a second position. Dependent on the position of the rotatable segment, different areas of field facets are illuminated in the plane 103 of FIG. 103 where the first facetted optical element with field facets is arranged. FIG. 11a again shows a collector which is composed of two shell segments 1500.1, 1500.2, 1500.3 and 1500.4. The segment 1500.2 can be set in two positions 1500.2A and 1500.2B, respectively. FIG. 11b shows the corresponding illumination in the plane 103 of FIG. 1, where the first facetted optical element with field raster elements is arranged. The contributions of the shell segments 1500.1, 1500.3, 1500.4 correspond to the illuminations in FIG. 10b and are identified as A10.1, A10.2 and A9.2. When the rotatable segment 1500.2 is in the position 1500.2A, it produces the illumination A9.1A, and in the position 1500.2B it produces the illumination A9.1B. As is clearly evident from FIG. 11b, different illuminations can be set by turning the segment 1500.2 into the two positions indicated.

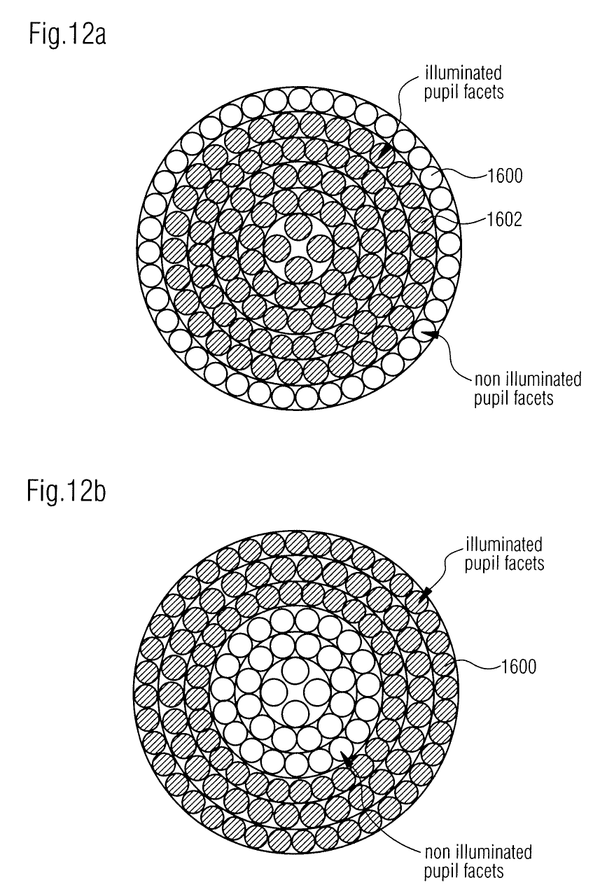

If different pupil facets of the second raster element 104 in FIG. 1 are assigned to different field facets as disclosed in U.S. Pat. No. 6,658,084, it is possible by turning the mirror shell 1500.2 to illuminate different pupil facets and thereby to select different settings in the exit pupil of the illumination system illustrated in FIG. 1. This is shown in FIGS. 12a and 12b.

FIGS. 12a and 12b illustrate the illumination on the second facetted optical element 104 with pupil facets.

If the mirror segment 1500.2 is in the first position, i.e. in the position 1500.2A, as shown in FIG. 11a, the illumination according to FIG. 12a is produced, meaning that the outermost pupil facets 1600 are not illuminated, so that a conventional circular-shaped setting is obtained in the exit pupil. If the segment 1502 is brought into the second position 1502B, the illumination according to FIG. 12b is obtained. The illuminated pupil facets 1600 are in the outer area and the non-illuminated pupil facets in the inner area. The result is a ring-shaped setting in the exit pupil.

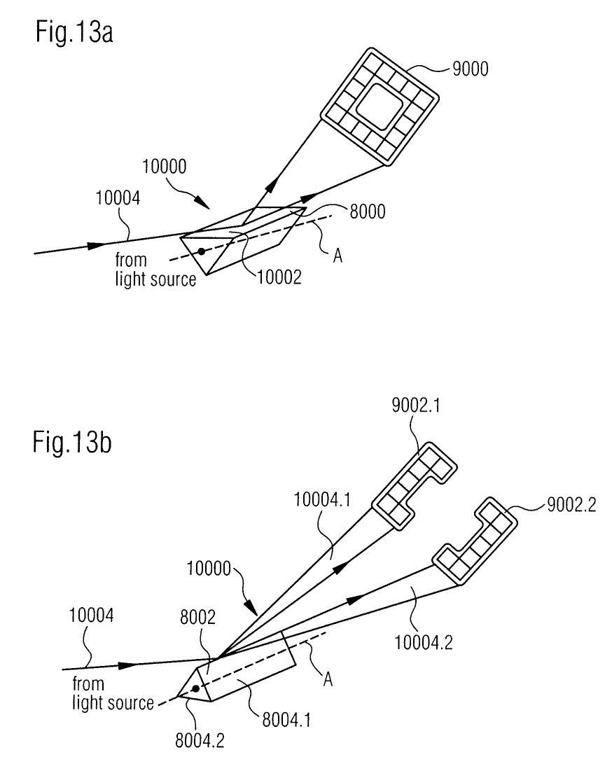

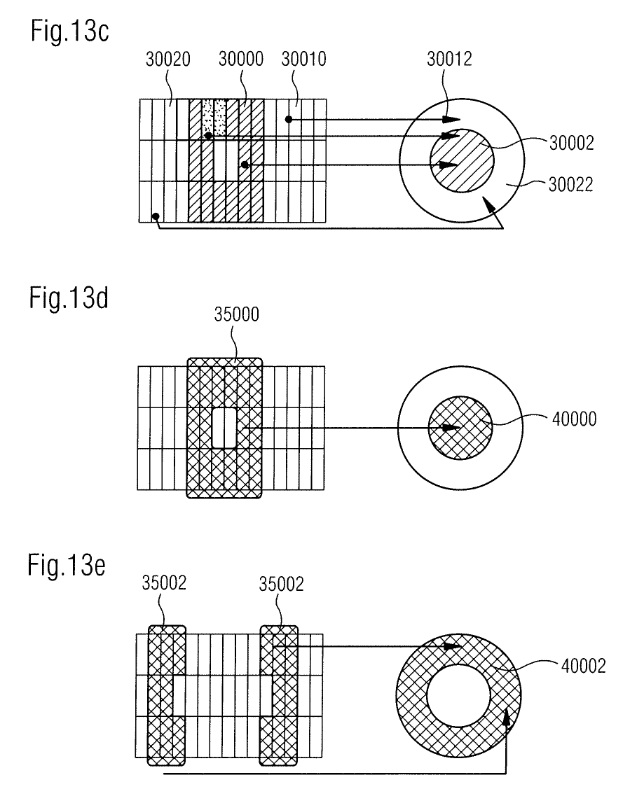

Instead of setting the shell segments into different positions as shown in FIGS. 11a and 11b in order to produce different illuminations on the second facetted optical element with pupil facets and thus to select different settings, it is also possible to introduce an optical selecting element in the light path after the collector and ahead of the facetted optical element with raster elements, as is shown in FIGS. 13a and 13b. This optical selecting element can be present for example instead of or in addition to the planar mirror 300 in the illumination system of FIG. 1. If the selecting element is now moved into different positions, this causes different areas of the first facetted optical element and thus different pupil facets on the pupil facet mirror to be illuminated, as shown in FIGS. 13a and 13b.

FIGS. 13a and 13b show a so-called roof-shaped mirror 10000 which is mounted in a way that allows the mirror to be set into two different positions by rotating it about an axis A. In a first position, which is shown in FIG. 13a, the roof-shaped mirror works as a first mirror 8000 in the light path in the same way as a planar mirror, for example the planar mirror 300 shown in FIG. 1.

The illumination on the optical element which is identified as 102 in FIG. 1, and thus the illumination on the first raster elements, is determined for example by the shape of the mirror shells of the collector 3. If these mirror shells are deformed essentially as shown in FIGS. 4b and 4d, an essentially rectangular illumination 9000 with a central obscuration is produced as shown in FIG. 13a. The light bundle which originates from a light source that is not shown in the drawing and falls on the planar portion 10002 of the roof-shaped mirror is reflected without being split up onto the optical element with first raster elements.

If a roof-shaped mirror 10000 is now turned about the optical axis A into the position shown in FIG. 13b, the light bundle 10004 which arrives on the roof-shaped mirror from the light source that is not shown here is split up into two light bundles 10004.1 and 10004.2, and two areas 9002.1 and 9002.2 of the field facet mirror are illuminated. In the case of FIG. 13b, different first raster elements, i.e. field raster elements, are illuminated than in FIG. 13a and thus, due to the assignment of field facets to pupil facets, different settings in the exit pupil can be achieved as shown in FIGS. 13c to 13e. In the second position, the roof-shaped mirror offers a second and a third reflective surface in the form of a second mirror 8002 with two reflective surfaces 8004.1 and 8004.2.

FIG. 13c shows in general terms the assignment of field raster elements to different pupil raster elements. In the illustrated arrangement, the field raster elements in the area 30000 are assigned to the pupil raster elements in the area 30002, and the pupil raster elements in the area 30010 are assigned to the pupil raster elements 30022.

As FIG. 13d shows, if an area 35000 of the kind shown in FIG. 13a is illuminated on the optical element with field raster elements, this amounts in essence to illuminating a conventionally filled pupil 40000.

If the roof-shaped mirror is brought into the position shown in FIG. 13b, an illumination 35002 as shown in FIG. 13e is set on the optical element with field raster elements. A circular-shaped illumination 40002 is realized in the pupil, because with the illumination of other field raster elements than those in FIG. 13c, different pupil raster elements are illuminated which, in turn lead to a different illumination in the exit pupil of the illumination system. Instead of changing the illumination of the first optical element with field raster elements through a rotatable roof-shaped mirror, it is also possible to exchange mirror elements and to thereby achieve different illuminations on the first raster element, for example via a mirror changer which can for example be a mirror wheel on which different mirrors are arranged. For example a planar mirror or also tilted mirrors with two mirror surfaces or with aspherical surfaces can be arranged on a mirror wheel.

The present disclosure is first in presenting a collector for an EUV projection objective which, in comparison to the prior-art collectors disclosed in US 2003/0043455A1, provides an illumination with a lower geometric loss of light. In some embodiments, fluctuations in the scan-integrated energy in the field plane, for example due to deformations of the individual mirror shells, are reduced.

As will be self-evident to any person skilled in the pertinent art, the present disclosure also encompasses embodiments which are obtained through a combination of features or an exchange of features between the embodiments described hereinabove.

1. A collector, comprising:
a first mirror shell; and
a second mirror shell,
wherein:
the first mirror shell is arranged inside the second mirror shell;
at least one mirror shell is a closed mirror surface which comprises a rotationally symmetric portion and a not rotationally symmetric portion;
the at least one mirror shell is selected from the group consisting of the first mirror shell and the second mirror shell; and
the collector is configured to be used in an illumination system having an operating wavelength of ≦193 nm.

2. The collector according to claim 1, wherein the at least one mirror shell comprises a first segment with a first optical surface and a second segment with a second optical surface.

3. The collector according to claim 2, wherein the first segment is a rotational hyperboloid, the second segment is a rotational ellipsoid, and the not rotationally symmetric portion is added to or subtracted from the rotational hyperboloid and/or the rotational ellipsoid.

4. The collector according to claim 1, wherein the at least one mirror shell has a symmetry axis.

5. The collector according to claim 4, wherein the symmetry axis is a common symmetry axis for the first mirror shell and the second mirror shell.

6. The collector according to claim 4, wherein the at least one mirror shell has an n-fold symmetry about the symmetry axis, wherein n is a positive integer.

7. The collector according to claim 6, wherein the symmetry about the symmetry axis is selected from the group consisting of a twofold symmetry, a threefold symmetry, a fourfold symmetry, a fivefold symmetry, a sixfold symmetry, a sevenfold symmetry and an eightfold symmetry.

8. The collector according to claim 1, wherein the collector is configured to receive light from a light source and direct the light into a plane which lies in the light path downstream of the collector, and wherein the not rotationally symmetric portion of the closed mirror shell is selected so that an illumination of substantially rectangular shape is present in the plane.

9. The collector according to claim 1, wherein the collector comprises a light barrier inside the mirror shell that is arranged closest to the axis.

10. The collector according to claim 1, wherein the first and second mirror shells are configured to direct light into a plane which lies in a light path downstream of the collector so that in the plane first and second illuminations are formed and are spaced apart from each other.

11. The collector according to claim 10, wherein the distance between the first and second illuminations is selected so that in case of a thermal deformation of the first or the second mirror shell or in case of a change of the light source in its shape or directional light-emission characteristic, the first and the second illuminations do not overlap each other in the plane.

12. The collector according to claim 11, wherein the distance is larger than 1 mm.

13. The collector according to claim 10, wherein a plurality raster elements are in the plane in an arrangement with a shape, and the at least one mirror shell has a geometric shape which corresponds substantially to the shape of the arrangement of the plurality of raster elements.

14. The collector according to claim 10, wherein the illumination has substantially a rectangular shape.

15. A collector, comprising:
a first article that is a first mirror shell or a first shell segment; and
a second article that is a second mirror shell or a second shell segment,
wherein:
the first and second articles are configured to receive light and direct it into a plane which lies in a light path downstream of the collector so that first and second illuminations are formed in the plane;
the first and second illuminations are spaced apart from each other; and
the collector is configured to be used in an illumination system with an operating wavelength of ≦193 nm.

16. The collector according to claim 15, wherein the distance between the first and second illuminations is selected so that in case of a thermal deformation of the first or the second mirror article, or in case of a change of the light source in its shape or directional light-emission characteristic, the first and the second illuminations are not overlapping each other in the plane.

17. The collector according to claim 15, wherein the distance is larger than 1 mm.

18. The collector according to claim 15, wherein a plurality of raster elements are arranged in the plane in a shape, and the first and/or second illumination has a geometric shape which corresponds substantially to the shape of the arrangement of the plurality of raster elements in the plane.

19. The collector according to claim 15, wherein the first and second illuminations have substantially a rectangular shape.

20. The collector according to claim 15, wherein the first article is a first shell, the article is a second shell, and the first and second shells are closed surfaces with rotational symmetry about an axis of rotation.

21. An illumination system, comprising:
a collector according to claim 1; and
a facetted optical element,
wherein:
the collector can be between a light source and a plane of illumination of the light source; and
the facetted optical element is in or near the plane.

22. The illumination system according to claim 21, wherein the facetted optical element comprises a plurality of field raster elements.

23. The illumination system according to claim 22, wherein the field raster elements of the facetted optical element are arranged in such a way that they lie substantially in the area of the illumination.

24. The illumination system according to claim 20, wherein the illumination system comprises an exit pupil plane and/or a pupil plane and the facetted optical element is configured in such a way that independent of the shape of an illumination in the plane), light source images are projected into an exit pupil plane and/or a pupil plane largely as faithful images of the object.

25. The illumination system according to claim 24, wherein the facetted optical element comprises field raster elements and the field raster elements have optical power and asphericity.

26. The illumination system according to claim 25, wherein different field raster elements have different asphericities.

27. The illumination system according to claim 21, wherein the illumination system comprises a pupil plane and a further facetted optical element, wherein the further facetted optical element is arranged in or near the pupil plane.

28. The illumination system according to claim 27, wherein the further optical element comprises a plurality of pupil raster elements.

29. The illumination system according to claim 28, wherein a pupil raster element is assigned to each of a large number of field raster elements according to a first allocation, and a pupil raster element is assigned to each of a second large number of field raster elements according to a second allocation.

30. The illumination system according to claim 29, wherein an optical selecting element is arranged in the light path downstream of the collector and before the facetted optical element, and wherein the optical selecting element in a first position illuminates a first large number of field raster elements and in a second position illuminates a second large number of field raster elements.

31. The illumination system according to claim 29, wherein in the light path downstream of the collector and before the facetted optical element different optical elements are introduced for the illumination of a different large number of field raster elements.

32. The illumination system according to claim 31, wherein the different optical elements are different mirrors.

33. The illumination system according to claim 32, wherein the different mirrors are arranged on a mirror support which is rotatable about an axis.

34. The illumination system according to claim 21, wherein the pupil plane is a conjugate plane to an exit pupil plane of the illumination system.

35. The illumination system according to claim 29, wherein the first allocation corresponds to a first illumination in an exit pupil plane and the second allocation corresponds to a second illumination in the exit pupil plane, and wherein the first illumination is different from the second illumination.

36. An apparatus, comprising:
a light source;
an illumination system, comprising:
a collector according to claim 1; and
a facetted optical element,
wherein:
the illumination system is configured to illuminate a field in a field plane;
the collector is between the light source and the field plane; and
the facetted optical element is in or near the field plane; and
a projection objective configured to project an image of an object in the field plane into an image plane of the projection objective,
wherein the apparatus is a projection exposure apparatus for microlithography.

37. A method, comprising:
using the projection exposure apparatus according to claim 36 to project an image of a structured mask onto a light-sensitive coating in the image plane of the projection objective; and
developing an image of the structured mask to produce at least a portion of a microelectronic component.
